(19) United States
(12) Patent Application Publication
(10) Pub. No.: US 2011/0203385 A1
(43) Pub. Date: Aug. 25, 2011

(54) Device for measuring torsions, bendings, and the like, and corresponding manufacturing method

(76) Inventors: Jan Huels, Reutlingen (DE); Frank Henning, Reutlingen (DE); Wilhelm Frey, Stuttgart (DE)

(21) Appl. No.: 12/932,144

(22) Filed: Feb. 17, 2011

(30) Foreign Application Priority Data
Feb. 24, 2010 (DE) 10 2010 002 274.8

(51) Int. Cl. G01N 3/22; B05D 3/06; B23K 31/02; G01N 3/20

(52) U.S. Cl. 73/847; 427/554; 228/170; 73/849

(57) ABSTRACT

A device for measuring torsions, bendings, and the like, of a target component includes a metallic substrate, an insulating layer, and a sensing layer in the form of a gauge system. The device is configured to be fixed to the target component via a fixed connection.

### BACKGROUND OF THE INVENTION

1. Field of the Invention

The present invention relates to a device for measuring torsions, bendings, and the like, and a corresponding manufacturing method.

2. Description of Related Art

It is known to use strain gauges for measuring torsions or bendings of components. Strain gauges are known from, e.g., published German utility model application document DE 90 170 56 U1, for example, and generally include a measuring grid foil made of resistance wire having a thickness of a few μm. The measuring grid foil is laminated onto a thin plastic substrate, in particular a film, etched out, and provided with electrical connections. Polyamide or epoxy resin is generally used as the carrier film. The strain gauge is then glued to a measuring site of a component to be measured.

As a result of the gluing, the strain gauge has a limited resolution accuracy due to the fact that the adhesive bond itself is part of the elongation, so that the elongation measured by the strain gauge does not exactly correspond to the actual elongation of the component. In addition, aging processes may cause the adhesive bond to change in such a way that the elongation measurement drifts over time or the sensitivity is altered. To achieve a sufficient measuring accuracy of a torsion or bending, the strain gauge must be appropriately dimensioned in order to substantially reduce the above-mentioned influences on the measuring accuracy.

### BRIEF SUMMARY OF THE INVENTION

A device for measuring torsions, bendings, and the like, of a component and the corresponding manufacturing method according to present invention have the advantage that very precise and reliable measurement of torsions, bendings, and the like, is possible. In addition, fatigue or aging of a connection between the device and the component is thus prevented. Lastly, the device is extremely sensitive and allows a decrease in the dimensions and therefore in the space requirements at the position to be measured on the component. The device and the manufacturing method are very cost-effective, since a plurality of devices may be manufactured at the same time. Furthermore, the device may also be used to measure twistings as well as compression forces and/or stretching forces, and also combinations thereof. In the context of the present disclosure, including the claims, a fixed connection is understood to mean a rigid and/or mechanically fixed connection which essentially is not subject to aging processes and has a nonelastic or nonplastic design.

Thus, the underlying concept of the present invention is to design currently known devices for measuring torsions, bendings, and the like, in such a way that a more reliable fixing of the device to the component, and at the same time more precise measurement of torsions, bendings, and the like, of the component, are possible.

According to one preferred refinement of the present invention, the in particular metallic substrate is connected to the insulating layer, and/or the insulating layer is connected to the sensing layer, via a rigid, fixed connection. The advantage is that forces may be transmitted directly between the substrate and the insulating layer, or between the insulating layer and the sensing layer; i.e., a torsion or elongation of a component is transmitted to the sensing layer with minimal losses. A precise measurement of torsions, bendings, and the like, by the sensing layer is thus possible. At the same time, extremely reliable fixing between the substrate and the insulating layer or between the insulating layer and the sensing layer is possible.

According to another preferred refinement, the sensing layer includes metal-like piezoresistive or piezoelectric layers and/or combinations thereof. The advantage is that the sensing layer may be optimally adapted to the measurements of torsions, bendings, and the like, to be carried out in each case.

According to one advantageous refinement, the in particular metallic substrate includes a metal plate for fixing the device to the component via the fixed connection, in particular via a welded connection. The advantage is that the metal plate allows a reliable connection of the device to the component, and at the same time allows a high sensitivity for the measurement of torsions, bendings, etc., since torsions, bendings, and the like, are directly transmitted from the component to the device.

According to one advantageous refinement, the metal plate includes a steel surface which in particular is polished, ground, lapped, trowalized, rolled, etched, and/or electropolished for applying the insulating layer. The advantage is that the insulating layer, in particular in the form of a hard, for example glasslike, layer, may be applied directly to the steel surface in a particularly simple manner, in particular with the aid of plasma deposition processes, for example PECVD processes. At the same time, optimal adhesion of the insulating layer to the steel surface is possible.

According to one preferred refinement, the device includes at least one evaluation device. The advantage is that measuring signals may be evaluated directly by the gauge system.

According to one preferred refinement, the device, in particular the metal plate, includes a recess. The advantage is that the device may be optimally adapted to specific requirements of the component, or also measuring requirements, by an appropriate design of the shape of the recess. In addition, the reliability of the fixed connection between the device, in particular the metal plate, and the component, as well as the measuring accuracy of the device are increased. Adapting the shape of the recess allows the load on the device, more precisely, on the gauges, to be influenced, depending on the requirements. If no recess is present, the load is distributed over the entire device. In particular for a metal plate having a recess in the region of the gauges, the sensitivity to the load is increased due to the fact that the load is concentrated in the region of the recess.

According to one preferred refinement, the device includes a housing. The advantage is that the gauge system may thus be protected from damage. Additional calibrations of the device are unnecessary. Within the meaning of the present invention, the term “housing” generally refers to any system used to protect the device from damage. The term “housing” is therefore also understood in particular to mean non-aging passivation, for example a nitride layer.

According to one preferred refinement, the device may be fixed in a recess of the component. This results in the advantage that measurements of torsions, bendings, or the like, of the component may also be carried out in regions of the component which would not be accessible without the recess.

According to one preferred refinement, the device, in particular the evaluation device, includes a transmitter for wireless transmission of data. The advantage is that for rotating components, for example, complicated laying of connecting cables may be dispensed with, thus expanding the overall field of application of the device and at the same time reducing the complexity for using the device. In particular when the evaluation device includes the transmitter, additional connections between the transmitter and the evaluation device may be dispensed with, which greatly simplifies the manufacture of the device.

According to one preferred refinement, the insulating layer includes an oxide layer. The advantage is that the insulating layer may be applied using industrial-scale processes, in particular PECVD.

According to one preferred refinement of the method according to the present invention, the device is fixed to the component by welding. The advantage is that a reliable and resistant fixed connection between the device and the component is made possible.

### BRIEF DESCRIPTION OF THE DRAWINGS

FIG. 1a shows a device according to a first specific embodiment of the present invention, in a top view.

FIG. 1b shows a device according to a seventh specific embodiment of the present invention, in a side view.

FIG. 1c shows a device according to an eighth specific embodiment of the present invention.

FIG. 2a shows a device according to a seventh specific embodiment, together with a component, in a side view.

FIG. 2b shows a device according to a seventh specific embodiment of the present invention, together with a component.

FIG. 2c shows a device according to a seventh specific embodiment and a component according to FIG. 2b, in a top view.

FIG. 2d shows a device according to a ninth specific embodiment of the present invention, together with a component.

FIG. 3a shows a detail of manufactured devices according to a twelfth specific embodiment of the present invention, in the top view.

FIG. 3b shows a detail of an eighth specific embodiment of the present invention, in a cross-sectional view.

### DETAILED DESCRIPTION OF THE INVENTION

In the figures, identical or functionally equivalent elements are denoted by the same reference numerals.

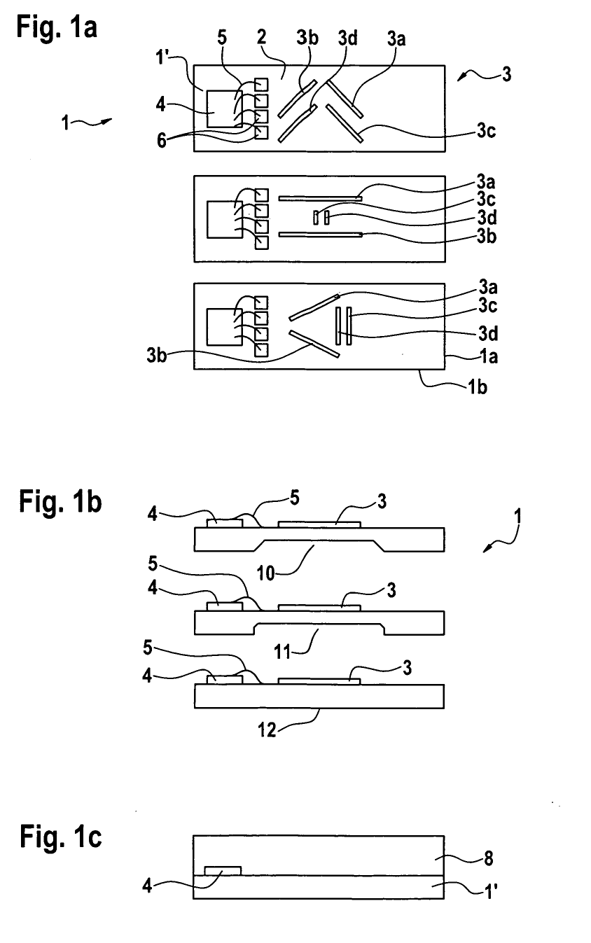

FIG. 1 shows a device according to one first specific embodiment of the present invention, in a top view.

In FIG. 1, reference numeral 1 denotes a device for measuring torsions, bendings, and the like, of a component (not shown) according to the first specific embodiment of the present invention. Device 1 includes a polished steel plate 1′ as the substrate, to which an insulating layer 2 is applied. A sensing layer 3 which has been partially removed by etching is in turn applied to insulating layer 2. The regions of sensing layer 3 which are not removed form a gauge system 3a, 3b, 3c, 3d having gauges 3a, 3b, 3c, 3d; gauges 3a, 3c and 3b, 3d in each case are oriented parallel to one another. In addition, gauges 3b, 3d are oriented mirror symmetrically with respect to gauges 3a, 3c, so that in each case the gauges are essentially oriented in a V shape.

According to one first specific embodiment, devices 1 illustrated in the middle and bottom parts of FIG. 1a differ from one another only in that gauge system 3a, 3b, 3c, 3d is different in each case. Device 1 in the middle part of FIG. 1a has two parallel longer gauges 3a, 3b and two further parallel gauges 3c, 3d which extend perpendicularly to longer gauges 3a, 3b. In device 1 according to the bottom part of FIG. 1a, two longer gauges 3a, 3b are oriented in a V shape, and two shorter gauges 3c, 3d oriented parallel to one another are situated in the region of the other, i.e., open, side of the V. Gauge system 3a, 3b, 3c, 3d of device 1 according to the top part of FIG. 1a has a very high sensitivity under torsion. In contrast, gauge system 3a, 3b, 3c, 3d of device 1 according to the middle part of FIG. 1a has a high sensitivity for a bending measurement, while gauge system 3a, 3b, 3c, 3d of device 1 according to the bottom part of FIG. 1a is insensitive to bending and is semi-sensitive to torsion.

FIG. 1b shows a device 1 according to a seventh specific embodiment of the present invention, in a side view.

FIG. 1b shows three alternative specific embodiments according to a seventh specific embodiment. The bottom part of FIG. 1b shows a device 1 which has no recesses on the bottom side, i.e., back side, of the substrate, in the present case metal plate 1′. On the other hand, the middle part of FIG. 1b shows a device 1 having an essentially trough-shaped recess 11 whose opening is situated on the opposite side of gauge system 3a, 3b, 3c, 3d. The top part of FIG. 1b likewise shows a device 1 having a metal plate 1′, which on its back side has a recess 10 having a trapezoidal cross section, which greatly simplifies the production of recess 10 by milling.

FIG. 1c shows a device according to an eighth specific embodiment. A housing 8 is situated on the top side of gauge system 3a, 3b, 3c, 3d, evaluation device 4, and wire bonds 5, and completely encloses gauge system 3a, 3b, 3c, 3d, evaluation device 4, and wire bonds 5 as well as the other regions of insulating layer 2. Device 1, gauge system 3a, 3b, 3c, 3d in particular, is thus completely protected from external or environmental influences.

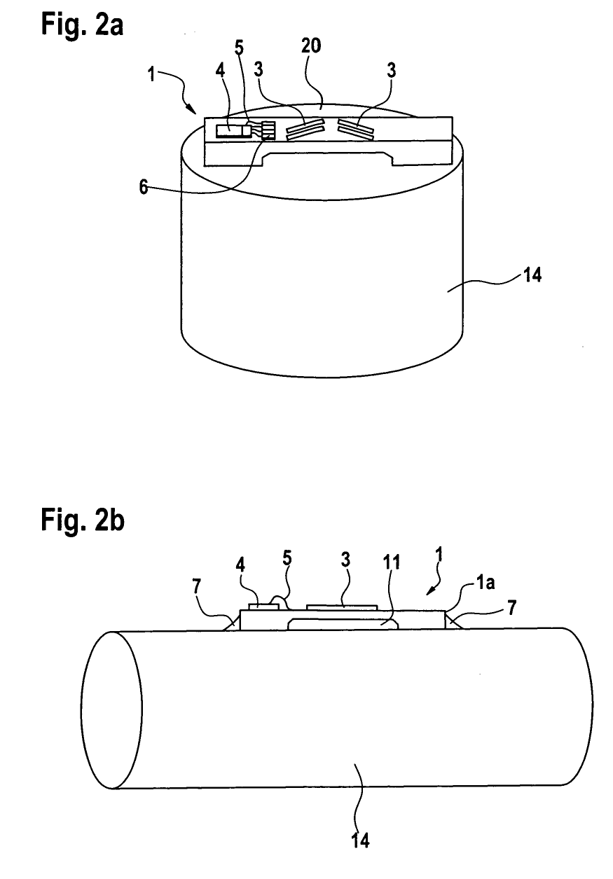

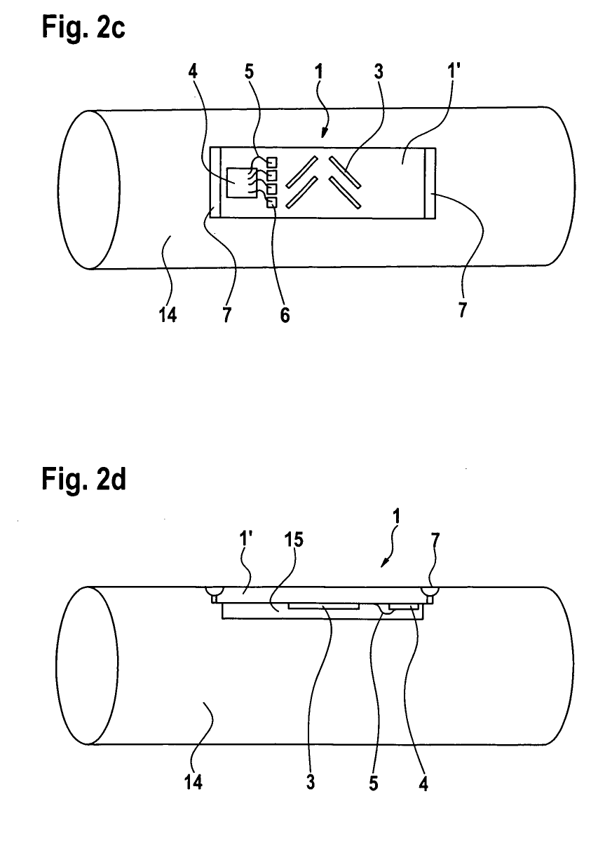

FIG. 2a shows a device 1 according to a seventh specific embodiment.

According to a seventh specific embodiment, device 1 is situated on a component 14 having a cylindrical design. Device 1 is situated on an end face 20, perpendicularly to the longitudinal axis of component 14. In contrast, in FIG. 2b device 1 is situated on a peripheral surface parallel to the axis of cylindrical component 14. The back side of rectangular metal plate 1′ is situated on the peripheral surface, so that a recess 11 is situated between the peripheral surface of component 14 and metal plate 1′. At edges 1a of metal plate 1′ shown in cross section according to FIG. 2, metal plate l′ and therefore device 1 is fixedly connected to a portion of the peripheral surface of component 14 via a welded connection 7.

FIG. 2c shows a device 1 and a component 14 according to FIG. 2b, in a top view. Welded connections 7 which connect metal plate 1′ to the peripheral surface of component 14 extend along shorter lateral edges 1a of rectangular metal plate 1′.

FIG. 2d shows a component 14 having a recess 15 for accommodating a device 1 according to a ninth specific embodiment. Metal plate 1′ is situated with respect to recess 15 in such a way that the back side of metal plate 1′ points outward, that gauge system 3 is situated inside recess 15, and that device 1 is fixed to component 14 via welded connection 7. Recess 15 in FIG. 2d is designed in such a way that it is able to completely accommodate device 1. Device 1, more precisely, the back side of metal plate 1′, is designed in such a way that the transition of the peripheral surface of component 14 and device 1 is continuous in order to avoid protruding areas. To avoid imbalance of component 14 during possible rotation, a corresponding recess (not shown) which is appropriately adapted, may be provided on the opposite side of component 14.

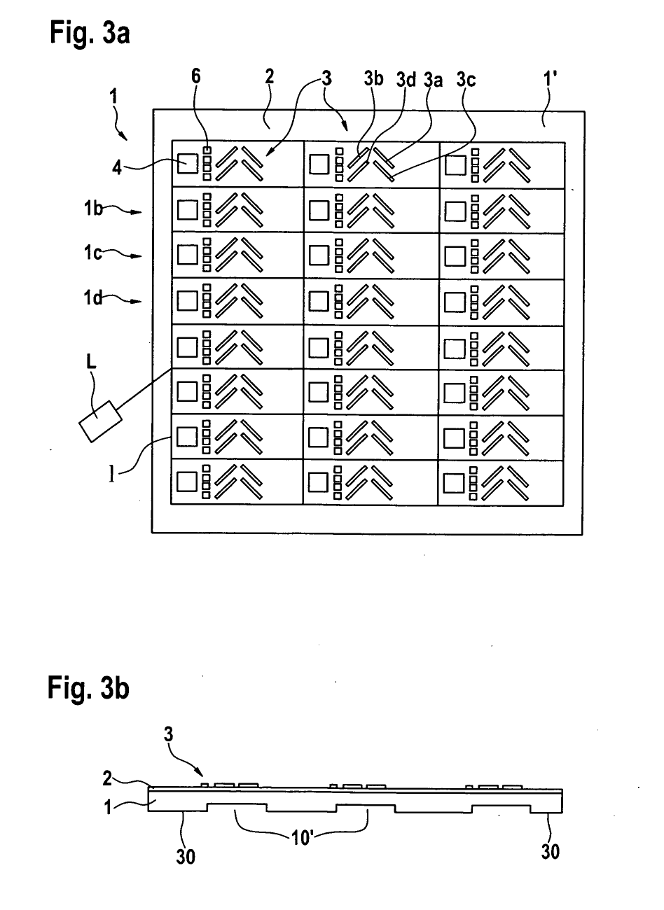

FIG. 3 shows a detail of a manufactured device according to a twelfth specific embodiment of the present invention, in the top view.

Devices 1, 1a, 1b, 1c, etc., shown in FIG. 3a are situated in essentially a checkerboard pattern on a shared metal plate 1′, which on its back side 30 (FIG. 3b) is provided with continuous recesses 10′ corresponding to the checkerboard pattern of devices 1, 1a, 1b, 1c, 1d. Recesses 10′ are situated in such a way that in the cross-sectional view, gauges 3a, 3b, 3c, 3d are centrally located on the opposite side of recess 10′, above the recess (see FIG. 3b). To separate devices 1, 1a, 1b, 1c, 1d, individual devices 1, 1a, 1b, 1c, 1d are separated according to the checkerboard pattern along lines, i.e., edges, 1 with the aid of a laser L; i.e., laser L cuts devices 1, 1a, 1b, 1c, 1d according to the particular edges 1 of the checkerboard pattern. Device 1 may then be used for measuring torsions, bendings, and the like, on a component B.

Although the present invention has been described above on the basis of preferred exemplary embodiments, it is not limited thereto, but is modifiable in numerous ways.

What is claimed is:

1. A device for measuring at least one of torsions and bendings of a component, comprising:
a metallic substrate;
an insulating layer;
a sensing layer in the form of a gauge system; and
a fixed connection fixing the device to the component.

2. The device as recited in claim 1, wherein at least one of (i) the metallic substrate is connected to the insulating layer via the fixed connection, and (ii) the insulating layer is connected to the sensing layer via the fixed connection, the fixed connection being a rigid fixed connection.

3. The device as recited in claim 1, wherein the sensing layer includes at least one of a metal-like layer, a piezoresistive layer, and a piezoelectric layer.

4. The device as recited in claim 1, wherein the metallic substrate includes a metal plate configured to fix the device to the component via the fixed connection, the fixed connection being a welded connection.

5. The device as recited in claim 4, wherein the metal plate includes a steel surface which is at least one of polished, ground, lapped, trowalized, rolled, etched, and electropolished for applying the insulating layer.

6. The device as recited in claim 1, further comprising at least one evaluation device.

7. The device as recited in claim 4, wherein the metal plate includes a recess.

8. The device as recited in claim 1, further comprising a housing.

9. The device as recited in claim 2, wherein the device is fixed in a recess of the component.

10. The device as recited in claim 6, wherein the evaluation device includes a transmitter configured to wirelessly transmit measuring data.

11. The device as recited in claim 1, wherein the insulating layer includes an oxide layer.

12. A method for manufacturing multiple devices each configured to measure at least one of torsions and bendings of a component, the method comprising:
applying an insulating layer to a metal plate;
applying a sensing layer in the form of a metal layer to the insulating layer;
structuring the sensing layer to produce at least one gauge; and
separating the multiple device with the aid of a laser.

13. The method as recited in claim 12, further comprising:
fixing at least one of the devices to the component by welding.
